(19) United States
(12) Patent Application Publication
(10) Pub. No.: US 2013/0147784 A1
(43) Pub. Date: Jun. 13, 2013

(54) METHODS AND APPARATUS TO CONTROL PRESENTATION DEVICES

(71) Applicant: Thomas Casey Hill, Crystal Lake, IL (US)

(72) Inventor: Thomas Casey Hill, Crystal Lake, IL (US)

(21) Appl. No.: 13/635,297

(22) PCT Filed: Nov. 22, 2011
(86) PCT No.: PCT/US11/61932

§ 371 Date: Sep. 14, 2012

(51) Int. Cl. G06T 11/00

(52) U.S. Cl. CPC G06T 11/00
USPC 345/418

(57) ABSTRACT

Example methods and apparatus to control presentation devices are described. One example method includes obtaining a context attribute of a mobile device, evaluating presentation criteria based on the context attribute, assigning an application on the mobile device for presentation on a first external presentation device based on the evaluation, and causing the application to be displayed on the first external presentation device

### FIELD OF THE DISCLOSURE

The present disclosure relates generally to mobile devices and, more particularly, to methods and apparatus to control presentation devices.

### BACKGROUND

It would be useful to provide a first electronic device which may be communicatively coupled with a second electronic device to allow the first electronic device to transfer presentation of an application to the second electronic device.

### BRIEF DESCRIPTION OF THE DRAWINGS

FIG. 1 illustrates an example system in which a mobile device is communicatively coupled with an external presentation device.

FIG. 2 illustrates an example controller to manage assignment of an application from a mobile device to an external presentation device.

FIGS. 3, 4, and 5 illustrate example flow diagrams representative of methods, which may be implemented using computer readable instructions, that may manage the assignment of an application from a mobile device to an external presentation device.

FIG. 6 is a block diagram of a mobile device in accordance with an example embodiment.

### DETAILED DESCRIPTION

A first electronic device may be communicatively coupled with a second electronic device to allow the first electronic device to transfer presentation of an application to the second electronic device. For example, the mobile device may transfer a presentation of an application executing on the mobile device to an external presentation device. The presentation may include audio, video, graphics, images, text, etc. As the electronic device is operated, the electronic device may be communicatively coupled with several electronic devices to which presentation of an application could be transferred.

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

For simplicity and clarity of illustration, where considered appropriate, reference numerals may be repeated among the figures to indicate corresponding or analogous elements. In addition, numerous specific details are set forth in order to provide a thorough understanding of examples disclosed herein. However, it will be understood by those of ordinary skill in the art that examples disclosed herein may be practiced without these specific details. In other instances, well-known methods, procedures and components have not been described in detail so as not to obscure examples disclosed herein. Also, the description is not to be considered as limiting the scope of examples disclosed herein.

Example methods, apparatus, and articles of manufacture disclosed herein may be used in connection with telephony-capable mobile devices, which may be any mobile communication device, mobile computing device, or any other element, entity, device, or service capable of communicating wirelessly. Mobile devices, also referred to as terminals, wireless terminals, mobile stations, communication stations, user equipment (UE), or user devices, may include mobile smartphones (e.g., BlackBerry® smartphones), cellular telephones, wireless personal digital assistants (PDA), tablet/laptop/notebook/netbook computers with wireless adapters, etc.

Example method, apparatus, and articles of manufacture disclosed herein facilitate the control of presentation devices communicatively coupled to a mobile device. In one example, such methods may include establishing a communication link from a mobile device to one or more external presentation devices, obtaining context attribute(s), evaluating presentation criteria based on the context attribute(s), and assigning applications to an external presentation device based on the presentation criteria. In some examples, the context attribute(s) may include a location of the mobile device and a location of the one or more external presentation devices and the presentation criteria may indicate that the application should be assigned to the external presentation device with the closest proximity.

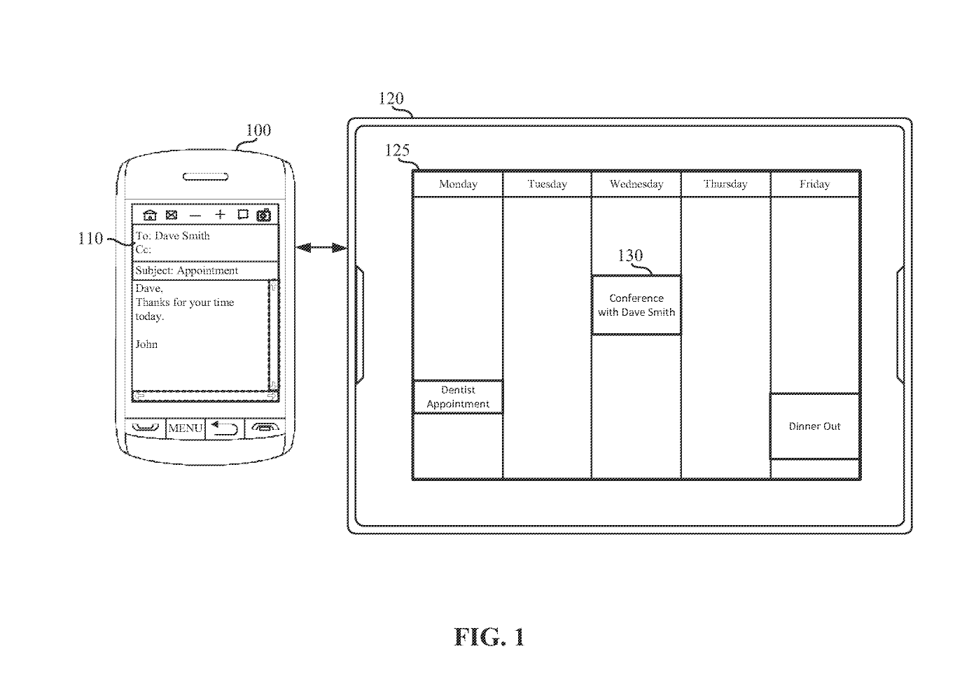

As shown in FIG. 1, mobile device 100 is communicatively coupled with an external presentation device 120. A first application 110 is presented on the mobile device 100. According to the illustrated example, the first application 110 is an e-mail application. However, any other application(s) may be presented on the mobile device 100. A second application 125 is presented on the external presentation device 120. According to the illustrated example, the second application is a calendar application that includes a scheduled event 130. However, any other application(s) may be presented on the external presentation device 120. In some examples, the first application 110 and the second application 125 may be the same.

The mobile device 100 may be any type of mobile device. In some examples, the mobile device 100 may alternatively be a non-mobile device. For example, the mobile device 100 may be a non-mobile device when the external presentation device 120 is a mobile device.

The external presentation device 120 may be any type of external presentation device. It may be a mobile device in example embodiments. According to the illustrated example, the external presentation device 120 is a tablet personal computer (also referred to herein as a tablet). Alternatively, the external presentation device 120 may be any type of mobile or non-mobile device, a monitor, a television, a laptop, a personal computer, a radio, one or more speakers, a telephone, or any device capable of presenting information such as audio, video, graphics, images, text, etc.

While a single mobile device 100 and a single external presentation device 120 are illustrated in the example of FIG. 1, any number of mobile devices and tablets may be communicatively coupled. For example, the mobile device 100 may be communicatively coupled to two or more tablets 120, the mobile device 100 may be communicatively coupled to a first external presentation device 120 in the first external presentation device 120 may be communicatively coupled to a second external presentation device 120, a first mobile device 100 may be communicatively coupled to the external presentation device 120 and a second mobile device 100 may be communicatively coupled to the external presentation device 120, and so forth.

According to the illustrated example of FIG. 1, the second application 125 is executed on the mobile device 100 and the user interface of the second application 125 is transmitted to the external presentation device 120. Alternatively, any other arrangement for execution and presentation of the second application 125 may be used. For example, the second application 125 may be executed and presented on the external presentation device 120, a first part of the second application 125 may be executed at the mobile device 100 and the second part of the second application 125 may be executed at the external presentation device 120, the second application 125 may be copied or otherwise transferred to the external presentation device 120, all or part of the second application 125 may be retrieved from a network by the external presentation device 120, data for use by the second application 125 may be retrieved from a network by the external presentation device, etc.

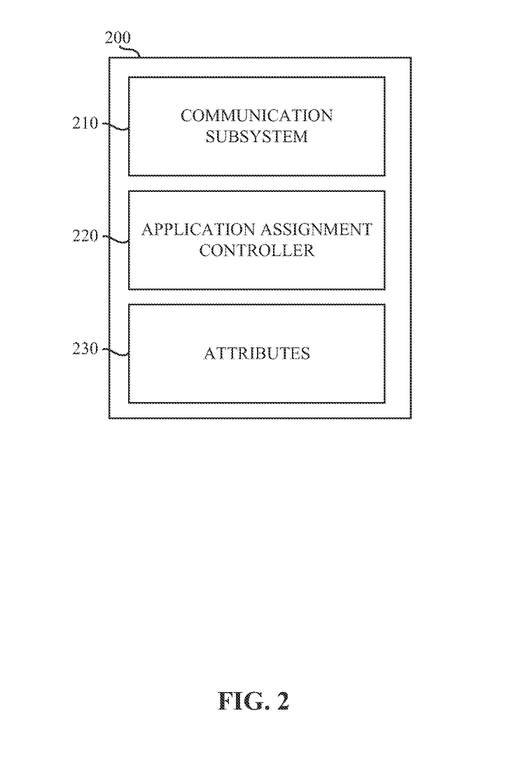

A block diagram of the example controller 200 to manage the assignment of the second application 125 to the external presentation device 120 is shown in FIG. 2. The example controller 200 includes a communication subsystem 210, and application assignment controller 220, and attributes 230.

Communication subsystem 210 communicatively couples the mobile device 100 with one or more external presentation device 120 to enable the mobile device 100 to assign the presentation of one or more applications to the external presentation device 120. For example, the communication subsystem 210 may receive an indication of the external presentation device 120 from the external presentation device 120, may transmit a presentation of the second application 125 to the external presentation device 120, may transmit the second application 125 to the external presentation device 120, may transmit data associated with the second application 125 to the external presentation device 120 (e.g., the scheduled event 130), etc. According to the illustrated example of FIG. 1, the communication subsystem 210 provides wireless communication. For example, the communication subsystem 210 may include a Bluetooth communication device, a near field communications (NFC) communication device, a Wi-Fi communication device, and infrared communication device, etc. Alternatively, the communication subsystem 210 may provide wired communication. In some examples, multiple wireless and/or wired communication devices may be used to communicatively couple the mobile device 100 with one or more external presentation devices 120.

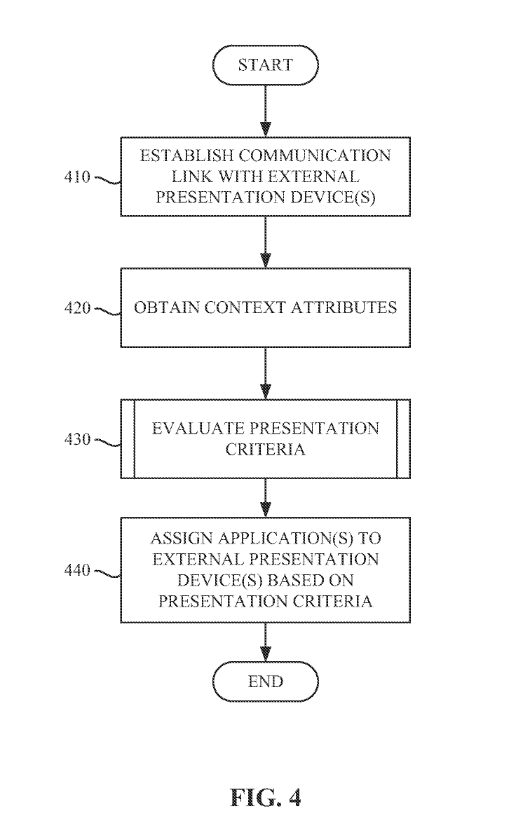

The application assignment controller 220 of the illustrated example manages the assignment of the second application 125 to the external presentation device 120. In some examples, the application assignment controller 220 assigns the second application 125 to the external presentation device 120 in response to evaluating presentation criteria based on context attributes. For example, the presentation criteria may specify that a device with the closest proximity should be selected, a device with the highest capabilities should be selected, a device nearest a location relevant to an application (e.g., a device located in a kitchen where the application is a recipe application), a certain device should be selected at a particular time of day while a different device should be selected at another time of day, etc. The flowchart of FIG. 4 illustrates an example of such a method.

The attributes 230 include information that may be used by the application assignment controller 220 to assign the second application 125 to the external presentation device 120. For example, as described in conjunction with FIG. 4, the application assignment controller 220 may evaluate presentation criteria based on the attributes 230. The attributes 230 may include, for example, information about the location of the mobile device 100, information about the location of the external presentation device 120, information on a calendar such as the scheduled event 130 on the calendar of the second application 125, the time of day, the date, the capabilities of the mobile device 100, the capabilities of the external presentation device 120, the requirements of the second application 125, the capabilities of the communication subsystem 210, information about a security level of the mobile device 100, information about a security level of the external presentation device 120, information about a setting of the mobile device 100, information about a setting of the external presentation device 120, etc.

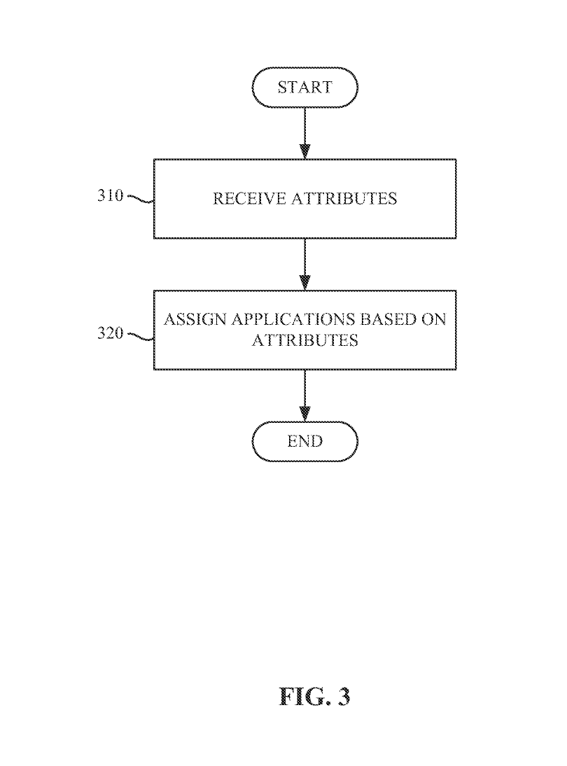

FIGS. 3, 4, and 5 illustrate example flow diagrams representative of methods that may be implemented using, for example, computer-readable instructions stored on a computer-readable medium to control presentation devices. The example methods of FIGS. 3, 4, and 5 may be performed using one or more processors, controllers, and/or any other suitable processing devices. For example, the example methods of FIGS. 3, 4, and 5 may be implemented using coded instructions (e.g., computer readable instructions) stored on one or more tangible computer readable media such as flash memory, read-only memory (ROM), and/or random-access memory (RAM). For example, the mobile device 100, the external presentation device 120, the controller 200, or the processor 602 may implement the methods of FIGS. 3, 4, and 5.

As used herein, the term tangible computer readable medium is expressly defined to include any type of computer readable storage and to exclude propagating signals. Additionally or alternatively, the example methods of FIGS. and 4 may be implemented using coded instructions (e.g., computer-readable instructions or machine-accessible instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information).

As used herein, the term non-transitory computer-readable medium and non-transitory machine-accessible medium are expressly defined to include any type of computer-readable medium or machine-accessible medium and to exclude propagating signals.

Alternatively, some or all operations of the example methods of FIGS. 3, 4, and 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all operations of the example methods of FIGS. 3 and 4 may be implemented manually or as any combination(s) of any of the foregoing techniques, for example, any combination of firmware, software, discrete logic and/or hardware. Further, although the example methods of FIGS. 3 and 4 are described with reference to the flow diagrams of FIGS. 3, 4, and 5, other methods of implementing the methods of FIGS. 3, 4, and 5 may be employed. For example, the order of execution of the blocks may be changed, and/or some of the blocks described may be changed, eliminated, sub-divided, or combined. Additionally, any or all operations of the example methods of FIGS. 3, 4, and 5 may be performed sequentially and/or in parallel by, for example, separate processing threads, processors, devices, discrete logic, circuits, etc.

In the illustrated example, the methods of FIGS. 3 and 4 are described below as performed by the mobile device 100 of FIG. 1. However, the example methods of FIGS. 3, 4, and 5 may additionally or alternatively be implemented using external presentation device 120 of FIG. 1 or any other suitable device or apparatus.

Turning to FIG. 3, an example method to assign an application from the mobile device 100 to the external presentation device 120 is shown. The method of FIG. 3 may be implemented using, for example, computer-readable instructions or any suitable combination of hardware and/or software. The application assignment controller 220 of the mobile device 100 receives attributes 230 (block 310). Application assignment controller 220 then determines an external presentation device on which to present an application by evaluating presentation criteria based on the attributes (block 320).

Now turning to FIG. 4, a further example method for controlling presentation devices is shown. The communication subsystem 210 of the mobile device 100 establishes a communication link with the external presentation device 120 (block 410). The application assignment controller 220 obtains context attributes from the attributes 230 (block 420). The application assignment controller 220 evaluates presentation criteria to determine an external presentation device (e.g., the external presentation device 120) to which an application is to be assigned (block 430). According to the illustrated example, the presentation criteria are evaluated based on the attributes obtained in block 420. Additionally or alternatively, the presentation criteria may be evaluated based on any other information. The presentation criteria may be any criteria indicative of how an application is to be assigned to the external presentation device 120. For example, the presentation criteria may be a rule defining how one or more external presentation devices should be selected for presentation of an application among a group of available external presentation devices. For example, when the mobile device 100 is in the presentation of a group of external presentation devices including the external presentation device 120, the application assignment controller 220 evaluates the presentation criteria based on the attributes 230 to determine one or more of the external presentation devices of the group of external presentation devices to which the presentation of an application should be assigned.

The application assignment controller 220 of the mobile device 100 then assigns the application to the external presentation device(s) determined based on the presentation criteria (block 440). As previously described, the application may be assigned to the external presentation device(s) by causing the application to be executed and presented on the external presentation device 120, by causing a first part of the application to be executed at the mobile device 100 and a second part of the application to be executed at the external presentation device 120, by copying the application or otherwise transferring the application to the external presentation device 120, by causing the external presentation device to receive data and or instructions from a network, etc.

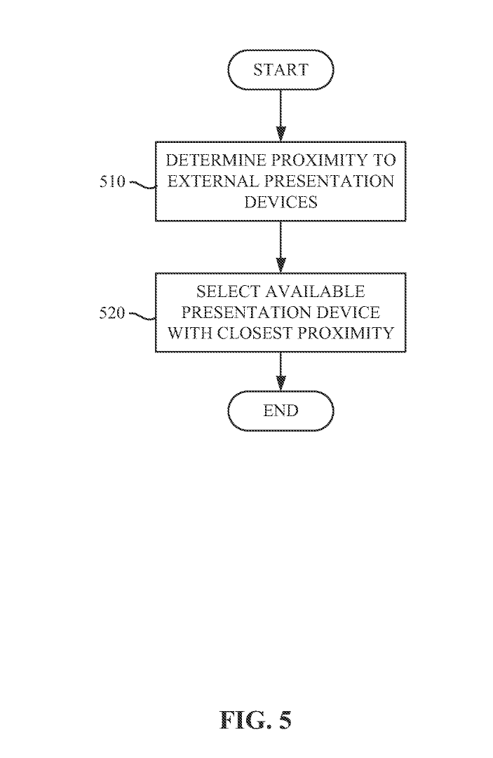

An example method to implement block 430 of FIG. 4 is shown in FIG. 5. According to the example method, the application assignment controller 220 determines a proximity of the mobile device 100 to one or more external presentation devices 120 based on the attributes 230 (block 510). For example, the attributes 230 may include global positioning system (GPS) information associated with the mobile device 100 and/or the external presentation device 120, may include a map, plot, or other layout of a building or other area, may include information about a signal strength for a communication link between the mobile device 100 and the external presentation device 120, may include information about a signal strength for a communication link between the mobile device 100 and any other wireless communication device, may include information about a signal strength for a communication link between the external presentation device 120 and any other wireless communication device, may include information about characteristics, capabilities, and/or requirements of the mobile device 100 and/or the external presentation device 120, may include a time of day, day of the week, and/or calendar date, may include information about nearby mobile devices and/or external presentation devices, and so forth.

According to the illustrated example, the application assignment controller 220 selects the external presentation device 120 that is closest in proximity to the mobile device 100 for presentation of the application (block 520). For example, the application assignment controller 220 may compare coordinates for the mobile device 100 to coordinates for the external presentation device 120 and any other external presentation devices to determine the external presentation that is closest. In some examples, where the attributes include information about the location of other mobile devices 100, the application assignment controller 220 may select the external presentation device 120 for which the mobile device 100 is the closest mobile device 100. In other words, the application assignment controller 220 may determine that a first external presentation device 120 is the closest to the mobile device but may select a second external presentation device 120 because another mobile device 100 is closer to the first external presentation device.

After the external presentation device 120 is selected (block 520), control proceeds to block 440 of FIG. 4 to assign the application to the selected external presentation device 120.

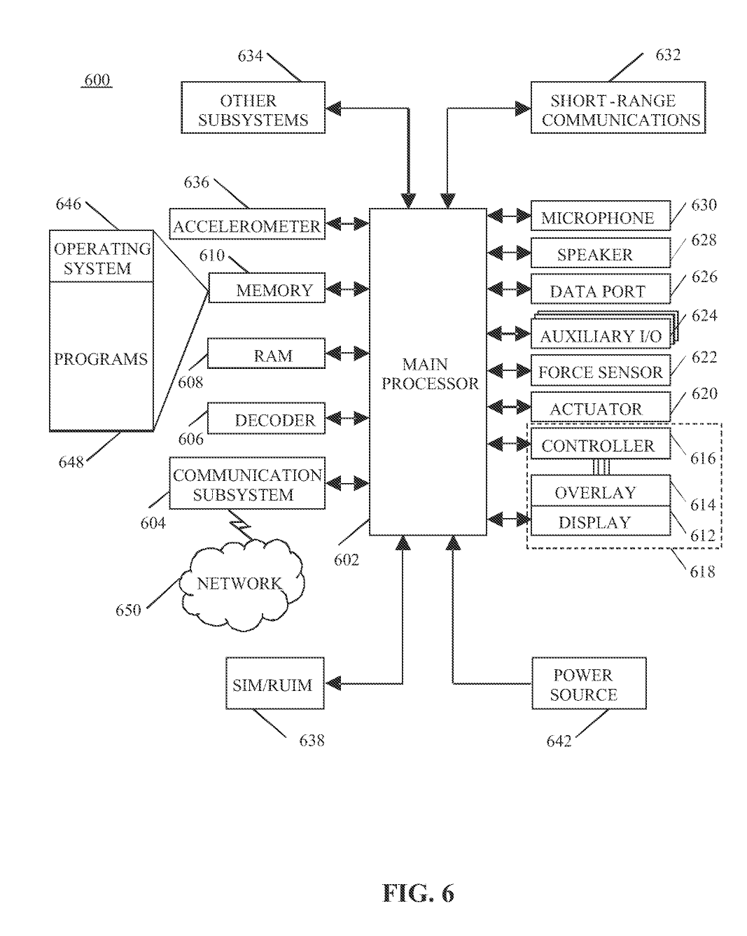

Further detail of certain aspects of the mobile devices 100 and the external presentation device 120 of FIG. 1 are shown in FIG. 6 with respect to a mobile device 600. The mobile device 600 includes multiple components, such as a main processor 602 that controls the overall operation of the mobile device 600. Communication functions, including data and voice communications, are performed through a communication subsystem 604. Data received by the mobile device 600 is decompressed and decrypted by a decoder 606. The communication subsystem 604 receives messages from and sends messages to a wireless network 650. The wireless network 650 may be any type of wireless network, including, but not limited to, data wireless networks, voice wireless networks, and networks that support both voice and data communications. A power source 642, such as one or more rechargeable batteries or a port to an external power supply, powers the mobile device 600.

The processor 602 interacts with other components, such as Random Access Memory (RAM) 608, memory 610, a display 612 with a touch-sensitive overlay 614 operably coupled to an electronic controller 616 that together comprise a touch-sensitive display 618, one or more actuators 620, one or more force sensors 622, an auxiliary input/output (I/O) subsystem 624, a data port 626, a speaker 628, a microphone 630, short-range communications 632, and other device subsystems 634. (In other example embodiments, there is no touch-sensitive display and therefore touch-sensitive overlay 614, electronic controller 616, actuator(s) 620 and force sensor(s) 622 are not included in mobile device 600.) In one example, the processor 602 and the memory 610 may cooperate to implement the functionality described in conjunction with the controller 200 of FIG. 2. For example, tangible and/or non-transitory, and/or machine readable instructions may be stored by the processor 602 and/or the memory 610 to implement the functionality shown in FIGS. 3, 4, and 5.

Input via a graphical user interface is provided via the touch-sensitive overlay 614 (or in example embodiments in which there is no touch-sensitive display, input is provided via auxiliary input/output (I/O) subsystem 624). The processor 602 interacts with the touch-sensitive overlay 614 (or auxiliary input/output (I/O) subsystem 624) via the electronic controller 616. Information, such as text, characters, symbols, images, icons, and other items that may be displayed or rendered on a mobile device, is displayed on display 612 via the processor 602. The processor 602 may interact with an accelerometer 636 that may be utilized to detect direction of gravitational forces or gravity-induced reaction forces.

To identify a subscriber for network access, the mobile device 600 may utilize a Subscriber Identity Module or a Removable User Identity Module (SIM/RUIM) card 638 for communication with a network, such as the wireless network 650. Alternatively, user identification information may be programmed into memory 610.

The mobile device 600 includes an operating system 646 and software programs, applications, or components 648 that are executed by the processor 602 and are typically stored in a persistent, updatable store such as the memory 610. Additional applications or programs may be loaded onto the mobile device 600 through the wireless network 650, the auxiliary I/O subsystem 624, the data port 626, the short-range communications subsystem 632, or any other suitable subsystem 634.

The mobile device 600 also includes a camera 650 and a projector 652. As described above, the camera 650 and the projector 652 may interoperate to present information, wherein the presentation may be coordinated between several mobile devices.

A received signal such as a text message, an e-mail message, or web page download is processed by the communication subsystem 604 and input to the processor 602. The processor 602 processes the received signal for output to the display 612 and/or to the auxiliary I/O subsystem 624. A subscriber may generate data items, for example e-mail messages, which may be transmitted over the wireless network 650 through the communication subsystem 604. For voice communications, the overall operation of the mobile device 600 is similar. The speaker 628 outputs audible information converted from electrical signals, and the microphone 630 converts audible information into electrical signals for processing.

In some example implementations in accordance with the disclosure, a mobile device may be in the presence of a group of external presentation devices. For example, the mobile device may be moved into proximity of multiple external presentation devices, one or more external presentation devices may be moved into proximity of the mobile device, etc. The external presentation devices may be any variety of available external presentation devices such as one or more tablets, televisions, display screens, audio devices, etc. One or more of the applications on the mobile device may be or have been selected for presentation on an external presentation device. The application may be a music application, a calendar application, a news application, a sports ticker application, a stock ticker application, an email application, etc. As disclosed herein, the mobile device evaluates presentation criteria to determine how to assign applications to external presentation devices. For example, a music application may be assigned to the nearest external presentation device that has the best audio output capabilities, a video application may be assigned to an external presentation device that has the best video output capabilities, a recipe display application may be assigned to a device that is nearest a kitchen or other cooking area, etc. An application may be assigned to an external presentation device based on an event on a calendar. For example, a sports ticket may be assigned to an external presentation device until the time of a meeting on a calendar at which time a slide presentation application is displayed on the external presentation device. Accordingly, the mobile device can selectively assign applications for presentation on a mobile device and such assignment can vary based on determined attributes of the device, environment, etc.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method comprising:
obtaining a context attribute of a mobile device;
evaluating presentation criteria based on the context attribute;
assigning an application on the mobile device for presentation on a first external presentation device based on the evaluation; and
causing the application to be displayed on the first external presentation device.

2. A method as in claim 1, wherein the context attribute includes a location of the mobile device.

3. A method as in claim 1, wherein the context attribute includes a time value stored on the mobile device.

4. A method as in claim 1, wherein the context attribute includes a proximity of the mobile device to the first external presentation device.

5. A method as in claim 1, wherein the context attribute includes an entry on a scheduled event stored on the mobile device.

6. A method as in claim 1, further comprising controlling the first external presentation device based on the evaluation.

7. A method as in claim 1, further comprising:
evaluating first capabilities of the first external presentation device and second capabilities of a second external presentation device; and
selecting the first external display device for presentation based on the first and second capabilities.

8. A method as in claim 1, wherein assigning comprises evaluating capabilities of the first external presentation device.

9. A method as in claim 1, wherein the presentation criteria includes a rule.

10. A non-transitory computer readable medium storing instructions that, when executed, cause a machine to:
obtain a context attribute of a mobile device;
evaluate presentation criteria based on the context attribute;
assign an application on the mobile device for presentation on a first external presentation device based on the evaluation; and
cause the application to be displayed on the first external presentation device.

11. A non-transitory computer readable medium as in claim 10, wherein the context attribute includes a location of the mobile device.

12. A non-transitory computer readable medium as in claim 10, wherein the context attribute includes a time value stored on the mobile device.

13. A non-transitory computer readable medium as in claim 10, wherein the context attribute includes a proximity of the mobile device to the first external presentation device.

14. A non-transitory computer readable medium as in claim 10, wherein the context attribute includes an entry on a scheduled event stored on the mobile device.

15. A non-transitory computer readable medium as in claim 10, wherein the instructions, when executed, further cause the machine to control the first external presentation device based on the evaluation.

16. A non-transitory computer readable medium as in claim 10, wherein the instructions, when executed, further cause the machine to:
evaluate first capabilities of the first external presentation device and second capabilities of a second external presentation device; and
select the first external display device for presentation based on the first and second capabilities.

17. A non-transitory computer readable medium as in claim 10, wherein assigning comprises evaluating capabilities of the first external presentation device.

18. A non-transitory computer readable medium as in claim 10, wherein the presentation criteria includes a rule.

19. A mobile wireless communication device comprising:
a housing;
a display carried by the housing;
a wireless receiver and transmitter carried by the housing;
a processor carried by the housing, coupled to the wireless receiver and transmitter, and coupled to the display, the processor configured to:
obtain a context attribute of the mobile wireless communication device;
evaluate presentation criteria based on the context attribute;
assign an application on the mobile wireless communication device for presentation on a first external presentation device based on the evaluation; and
cause the application to be displayed on the first external presentation device.

20. A mobile wireless communication device as in claim 19, wherein the context attribute includes a location of the mobile wireless communication device.

21. A mobile wireless communication device as in claim 19, wherein the context attribute includes a time value stored on the mobile wireless communication device.

22. A mobile wireless communication device as in claim 19, wherein the context attribute includes a proximity of the mobile wireless communication device to the first external presentation device.

23. A mobile wireless communication device as in claim 19, wherein the context attribute includes an entry on a scheduled event stored on the mobile wireless communication device.

24. A mobile wireless communication device as in claim 19, wherein the processor is configured to control the first external presentation device based on the evaluation.

25. A mobile wireless communication device as in claim 19, wherein the processor is configured to:
evaluate first capabilities of the first external presentation device and second capabilities of a second external presentation device; and
select the first external display device for presentation based on the first and second capabilities.

26. A mobile wireless communication device as in claim 19, wherein assigning comprises evaluating capabilities of the first external presentation device.

27. A mobile wireless communication device as in claim 19, wherein the presentation criteria includes a rule.
